(19) United States
(12) Patent Application Publication
(10) Pub. No.: US 2010/0071365 A1
(43) Pub. Date: Mar. 25, 2010

(54) EXHAUST GAS RECIRCULATION SYSTEM

(75) Inventors: Martin Laermann, Clarkston, MI (US); Dean Tomazic, Orion Township, MI (US); Marek Tatur, Auburn Hills, MI (US)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 12/237,603

(22) Filed: Sep. 25, 2008

(51) Int. Cl. F02B 47/08; F02B 33/40; F01N 3/021; F02M 25/07

(52) U.S. Cl. 60/605.2; 60/612; 60/311; 123/568.11

(57) ABSTRACT

An exhaust gas recirculation system for an internal combustion engine is disclosed. The exhaust gas recirculation system can include a first turbocharger and a second turbocharger with a particulate filter located between the two turbochargers. The first turbocharger can have a first exhaust turbine and a first charger while the second turbocharger can have a second exhaust turbine and a second charger. The particulate filter can be located between the first exhaust turbine and the second exhaust turbine and thereby remove particulates from an exhaust gas before it reaches the second exhaust turbine. In some instances, an exhaust gas recirculation line can be included and have an inlet that is located downstream from the particulate filter. In addition, the exhaust gas recirculation line can have an outlet that is located between the first charger and the second charger, or in the alternative downstream from the first charger. It is appreciated that the internal combustion engine can be a diesel engine and the particulate filter can be a diesel particulate filter.

### FIELD OF THE INVENTION

The present invention relates to an exhaust gas recirculation system for an internal combustion engine, and more particularly, to an exhaust gas recirculation system having a particulate filter located between a first turbocharger and a second turbocharger.

### BACKGROUND OF THE INVENTION

The use of exhaust gas recirculation (EGR) systems in internal combustion engines is known. An EGR system is typically used to reduce nitrogen oxide emissions by recirculating a portion of an engine's exhaust gas back through the engine cylinders. Mixing of the exhaust gas with incoming air dilutes the mix with inert gas and thereby lowers the adiabatic flame temperature. Lowering the adiabatic flame temperature can reduce the amount of excess nitrogen oxides. Stated differently, the mixing or incoming air with inert gas cools combustion chamber temperatures to levels that result in the reduction of formation of nitrogen oxides.

The use of turbochargers with internal combustion engines is also known. A turbocharger is essentially an air compressor that is used to force additional air into the internal combustion engine. The air compressor is powered by a turbine that is driven by the engine's own exhaust gases. The turbine inlet receives the exhaust gases from the engine causing a turbine wheel to rotate, this rotation also driving the compressor which compresses ambient air and delivers it to the intake manifold of the engine at higher pressure. The compressed air provides for a greater amount of air entering into cylinders of the engine and can result in reduced fuel consumption and emissions.

In diesel engines, a diesel particulate filter (DPF) can work in combination with the EGR system and an oxidation catalyst to remove a majority of the nitrogen oxides, particulate matter and unburned hydrocarbons from burned diesel fuel. The DPF can have a porous honeycomb structure or a structure of a plurality of thin metal sheets, both structures affording for the catching or entrapping of soot as it passes through the exhaust gas system. The use of a DPF in combination with a downstream turbocharger can improve fuel economy, however a decrease in performance typically results. As such, an exhaust gas recirculation system that combines the use of a DPF with a turbocharger and still provide improved performance would be desirable.

### SUMMARY OF THE INVENTION

An exhaust gas recirculation system for an internal combustion engine is disclosed. The exhaust gas recirculation system can include a first turbocharger and a second turbocharger with a particulate filter located between the two turbochargers. The first turbocharger can have a first exhaust turbine and a first charger while the second turbocharger can have a second exhaust turbine and a second charger. The particulate filter can be located between the first exhaust turbine and the second exhaust turbine and thereby remove particulates from an exhaust gas before it reaches the second exhaust turbine. In some instances, an exhaust gas recirculation line can be included and have an inlet that is located downstream from the particulate filter. In addition, the exhaust gas recirculation line can have an outlet that is located between the first charger and the second charger, or in the alternative downstream from the first charger. It is appreciated that the internal combustion engine can be a diesel engine and the particulate filter can be a diesel particulate filter.

### BRIEF DESCRIPTION OF THE DRAWINGS

FIG. 1 is a schematic illustration of an internal combustion engine having a particulate filter, an exhaust gas recirculation line and a turbocharger;

FIG. 2 is a schematic representation of an embodiment of the present invention;

FIG. 3 is a schematic representation of the outlined area labeled 3 in FIG. 2;

FIG. 4 is a schematic representation of another embodiment of the present invention;

FIG. 5 is a schematic representation of the outlined area labeled 5 in FIG. 4; and

FIG. 6 is a schematic representation of the outlined area labeled 6 in FIG. 4.

### DETAILED DESCRIPTION OF THE INVENTION

The present invention discloses an exhaust gas recirculation (EGR) system for an internal combustion engine. As such, the EGR system has utility as a component for an internal combustion engine.

The EGR system can include a first turbocharger having a first exhaust turbine and a first compressor and a second turbocharger having a second exhaust turbine and a second compressor. The first exhaust turbine can be located downstream from an exhaust outlet, also known as an exhaust manifold, of the engine and the second exhaust turbine located between the exhaust manifold and the first exhaust turbine. A particulate filter can be located between the first exhaust turbine and the second exhaust turbine. The first and second exhaust turbines are driven by the exhaust gas from the engine, and provide power to a first compressor that is located upstream from an air intake manifold of the engine and a second compressor that is located between the air intake manifold and the first compressor, respectively. An EGR line can also be included, the EGR line having an inlet located between the first exhaust turbine and the second exhaust turbine and optionally downstream from the particulate filter. The EGR line can also have an outlet that is located between the first compressor and the second compressor, and/or downstream from the second compressor. In some instances, the internal combustion engine is a diesel engine and the particulate filter is a diesel particulate filter (DPF).

It is appreciated that the internal combustion engine has an air inlet line and an exhaust gas line. For the purposes of the present invention, the terms air inlet line and exhaust gas line refer to the tubing, piping, passageways and the like through which air is supplied to and exhaust is removed from the engine, respectively. It is further appreciated that one skilled in the art can discuss an EGR system for an internal combustion engine with the air inlet line and exhaust gas line assumed to be present and thus may or may not be mentioned.

A diesel engine can have a first turbocharger with a first exhaust turbine that is in fluid communication with an exhaust gas line and a first compressor that is in fluid communication with an air inlet line. In addition, a second turbocharger can be included with a second exhaust turbine in fluid communication with the exhaust gas line and a second compressor in fluid communication with the air inlet line. A DPF can be in fluid communication with the exhaust gas line and be located between the first exhaust turbine and the second exhaust turbine. Downstream from the DPF and upstream from the first exhaust gas turbine an EGR line inlet can be located which affords for exhaust gas that has passed through the DPF to be recirculated into the diesel engine. The EGR line has an outlet, the outlet being in fluid communication with the air inlet line and located upstream of the second compressor and/or downstream of the second compressor.

A process for recirculating exhaust gas in an internal combustion engine is also disclosed, the process including providing the EGR system as described above and operating the engine such that air flows in through the air inlet line and exhaust gas flows out through the exhaust gas line. The exhaust gas flows through the second exhaust gas turbine, then through the particulate filter, with part of the exhaust gas diverted through the EGR line into the air inlet line. It is appreciated that flowing of the exhaust gas through the second exhaust turbine drives the second compressor. Flowing the exhaust gas through the particulate filter removes particulates from the gas and thereby produces a “clean” exhaust gas and flowing the clean exhaust gas back through the engine provides for reduced nitrogen oxide emissions, improved fuel economy and/or improved performance.

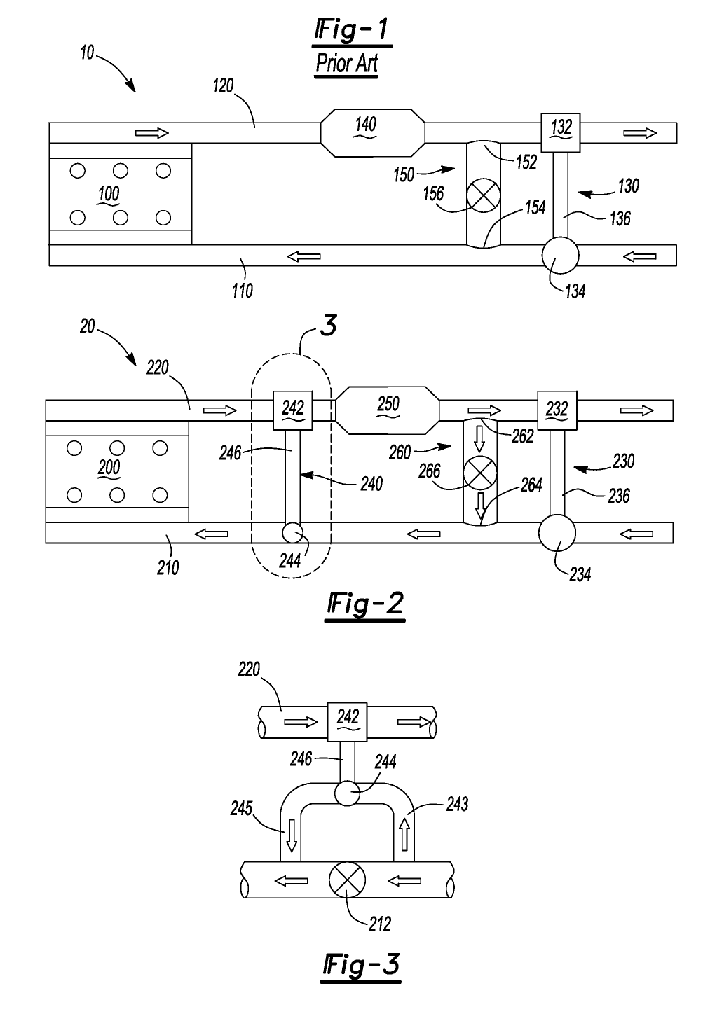

Turning now to FIG. 1, a schematic illustration of a prior art EGR system with a single turbocharger is illustrated generally at reference numeral 10. The prior art system 10 includes an engine 100 having an air inlet line 110 and an exhaust gas line 120. Air flows through the air inlet line 110 and can be forced at a greater rate and/or pressure into the engine 100 using a compressor 134. The compressor 134 is part of a turbocharger 130 and is driven by an exhaust turbine 132. It is appreciated that the exhaust turbine 132 is powered by exhaust gas exiting the engine 100 and flowing through the exhaust gas line 120. Upstream from the exhaust turbine 132 can be a particulate filter 140 and an EGR line 150. The EGR line 150 can have an inlet 152 that is in fluid communication with the air inlet line 120 and an outlet 154 that is in fluid communication with the air inlet line 110. A valve 156 can also be included, the valve 156 affording for variable amounts of exhaust gas being diverted from the exhaust gas line 120 and thus being mixed with air in the air inlet line 110 and recirculated to the engine 100. It is appreciated that the engine 100 can be a diesel engine and the particulate filter 140 can be a diesel particulate filter. As stated above, such a configuration can result in a decrease in performance for a diesel engine.

Turning now to FIG. 2, an embodiment of an EGR system is shown generally at reference numeral 20. The EGR system 20 can include an engine 200 with an air inlet line 210 that provides air to the cylinders of the engine 200 and an exhaust gas line 220 that aids in the removal of exhaust gas therefrom. The EGR system 20 also includes a first turbocharger 230 and a second turbocharger 240. The first turbocharger 230 has a first exhaust turbine 232 that is in fluid communication with the exhaust gas line 220 and a first compressor 234 that is in fluid communication with the air inlet line 210. In addition, a connecting means 236, illustratively including a shaft, connects the first exhaust turbine 232 to the first compressor 234 such that when exhaust gas exiting from the engine turns the exhaust turbine 232, the compressor 234 is driven and provides for increased air flow to the engine 200.

The second turbocharger 240 can include a second exhaust turbine 242 that is in fluid communication with exhaust gas line 220 and a second compressor 244 that is in fluid communication with the air inlet line 210. In addition, a connection means 246, illustratively including a shaft, can connect the second exhaust turbine 242 to the second compressor 244. It is appreciated that the second exhaust turbine 242 is located downstream from the engine 200 and upstream from the first exhaust turbine 232. Likewise, the first compressor 244 is located upstream from the engine 200 and downstream from the first compressor 234.

Located between the first exhaust turbine 232 and the second exhaust turbine 242 is a particulate filter 250 that is in fluid communication with the exhaust gas line 220. In some instances, the particulate filter 250 is downstream from the second exhaust turbine 242 and upstream from the first exhaust turbine 232. In addition, the engine 200 can be a diesel engine and the particulate filter 250 can be a diesel particulate filter.

An EGR line 260 can be included as part of the EGR system 20, the EGR line 220 having an inlet 262 that is in fluid communication with the exhaust gas line 220 and an outlet 264 that is in fluid communication with the air inlet line 210. In this manner, exhaust gas flowing through the exhaust gas line 220 can be diverted to the air inlet line 210. In some instances, a valve 266 can be included within the EGR line 260 such that the amount of exhaust gas diverted from the exhaust gas line 220 to the air inlet line 210 can be controlled. As shown in FIG. 2, the inlet 262 can be located downstream from the particulate filter 250 and the outlet 264 can be located upstream from the second compressor 244. In this manner, clean exhaust gas is fed into the air inlet line 210 and through the second compressor 244.

Turning now to FIG. 3, the circled region labeled 3 in FIG. 2 is shown with a bypass loop for the second compressor 244. FIG. 3 illustrates that the bypass loop can have an inlet line 243 and an outlet line 245 and affords for part of the air plus exhaust gas mixture to flow through the second compressor 244 and part of the mixture to bypass the compressor. In this manner, overloading of the compressor 244 can be prevented. The amount of exhaust gas plus air mixture that passes through the second compressor 244 can be controlled by the valve 266 and/or by an additional valve 212.

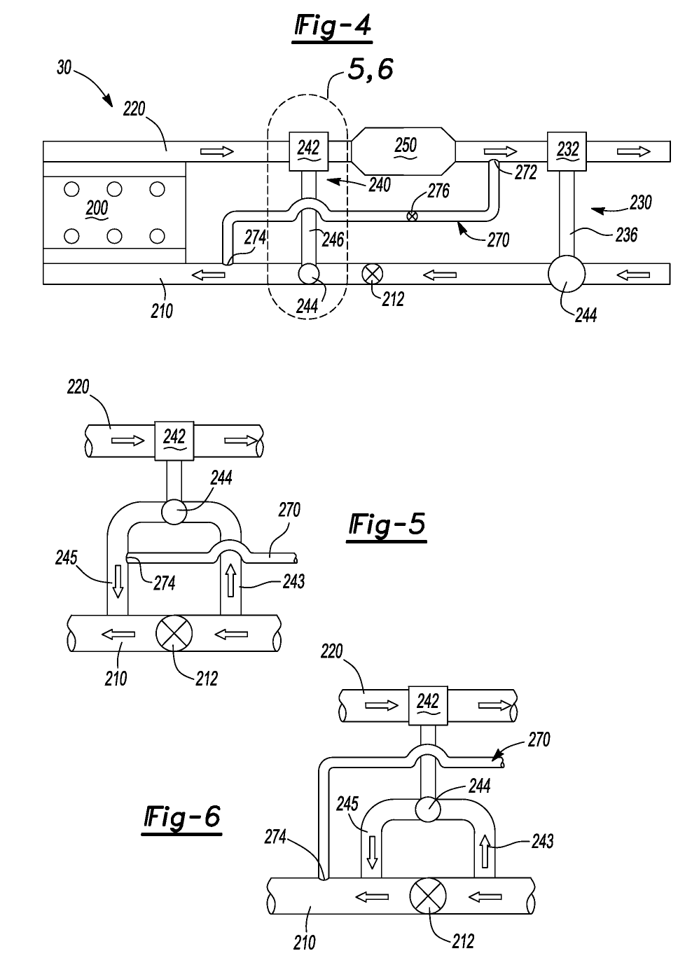

Turning now to FIG. 4 where like numerals correspond to like elements as described in FIGS. 2 and 3, another embodiment of an EGR system is shown generally at reference numeral 30. In this embodiment, an EGR line 270 has an inlet 272 that is in fluid communication with the exhaust gas line 220 and an outlet 274 that is in fluid communication with the air inlet line 210. However, in this embodiment, the outlet 274 is in fluid communication with the air inlet line 210 downstream of the second compressor 244. In this manner, only air that is brought through the air inlet line 210 is compressed by the second compressor 244, which is in contrast to the embodiment shown in FIGS. 2 and 3 where air and exhaust gas are both compressed by the second compressor 244.

Turning now to FIGS. 5 and 6, the circled region shown in FIG. 4 is shown with two different embodiments. In FIG. 5, one embodiment provides for the outlet 274 to be in fluid communication with the outlet line 245 downstream from the second compressor 244. In FIG. 6 another embodiment provides for the EGR line 270 bypasses the outlet line 245 of the second compressor 244 by being directly in fluid communication with the air inlet line 210 downstream from the exit line 245. Both embodiments accomplish the same task, in particular affording for the second compressor to compress only air and not a mixture of air and exhaust gas.

It is appreciated that the engine 200, the first turbocharger 230, the second turbocharger 240, the particulate filter 250 and the EGR line 260, 270 can have additional components that are not shown in the figures but known to those skilled in the art. Those skilled in the art will thus understand that such components can be included and not fall outside the scope of the present invention. In addition, it is known to those skilled in the art that a range of materials, illustratively including metals, alloys, ceramics, and plastics can be used to construct the EGR system and still fall within the scope of the present invention. The invention is not restricted to the illustrative embodiments and examples described above. The embodiments and the examples are not intended as limitations on the scope of the invention. Methods, apparatus, compositions and the like described herein are exemplary and not intended as limitations on the scope of the invention. Changes therein and other uses will occur to those skilled in the art. The scope of the invention is defined by the scope of the claims.

We claim:

1. An exhaust gas recirculation system for an internal combustion engine comprising:
a first turbocharger having a first exhaust turbine and a first compressor;
a second turbocharger having a second exhaust turbine and a second compressor; and
a particulate filter located between said first turbocharger and said second turbocharger.

2. The exhaust gas recirculation system of claim 1, wherein said particulate filter is located between said first exhaust turbine and said second exhaust turbine.

3. The exhaust gas recirculation system of claim 1, further comprising an exhaust gas recirculation line, said exhaust gas recirculation line having an inlet located downstream from said particulate filter.

4. The exhaust gas recirculation system of claim 3, wherein said exhaust gas recirculation line has an outlet located between said first compressor and said second compressor.

5. The exhaust gas recirculation system of claim 3, wherein said exhaust gas recirculation line has an outlet located downstream said first compressor.

6. The exhaust gas recirculation system of claim 1, wherein said particulate filter is a diesel particulate filter.

7. A internal combustion engine having an exhaust gas recirculation system, said internal combustion engine comprising:
a diesel engine having an air inlet line and an exhaust gas line;
a first turbocharger having a first exhaust turbine in fluid communication with said exhaust gas line and a first compressor in fluid communication with said air inlet line;
a second turbocharger having a second exhaust turbine in fluid communication with said exhaust gas line and a second compressor in fluid communication with said air inlet line;
a diesel particulate filter in fluid communication with said exhaust gas line and located between said first exhaust turbine and said second exhaust turbine; and
an exhaust gas recirculation line having an inlet end and an outlet end, said inlet end in fluid communication with said exhaust gas line and located downstream from said diesel particulate filter and said outlet end in fluid communication with said air inlet line.

8. The internal combustion engine of claim 7, wherein said outlet end of said exhaust gas recirculation line is located upstream of said first compressor.

9. The internal combustion engine of claim 7, wherein said outlet end of said exhaust gas recirculation line is located downstream of said first compressor.

10. A process for recirculating exhaust gas in a diesel engine, the process comprising:
providing a diesel engine having:
an air inlet line and an exhaust gas line;
a first turbocharger having a first exhaust turbine in fluid communication with said exhaust gas line and a first compressor in fluid communication with said air inlet line;
a second turbocharger having a second exhaust turbine in fluid communication with said exhaust gas line and located downstream said first exhaust turbine, said second turbocharger also having a second compressor in fluid communication with said air inlet line and located upstream said first compressor;
a diesel particulate filter in fluid communication with said exhaust gas line and located between said first exhaust turbine and the second exhaust turbine; and
an exhaust gas recirculation line having an inlet end and an outlet end, said inlet end in fluid communication with said exhaust gas line and located downstream from said diesel particulate filter and said outlet end in fluid communication with said air inlet line;
operating the diesel engine such that air flows through said air inlet line and exhaust gas flows through said exhaust gas line;
flowing the exhaust gas through the first exhaust gas turbine;
flowing the exhaust gas through the diesel particulate filter after it passes through the first exhaust gas turbine;
diverting at least part of the exhaust gas from the exhaust gas line through the exhaust gas recirculation line after the exhaust gas has passed through the diesel particulate filter; and
flowing the diverted exhaust gas from the exhaust gas recirculation line into the air inlet line.

11. The process of claim 10, wherein the diverted exhaust gas flows into the air inlet line upstream said first compressor.

12. The process of claim 10, wherein the diverted exhaust gas flows into the air inlet line downstream said first compressor.
